(19) United States
(12) Patent Application Publication
(10) Pub. No.: US 2024/0424584 A1
(43) Pub. Date: Dec. 26, 2024

(54) MANUFACTURE OF DIFFERENTIAL GEARS

(71) Applicant: THE GLEASON WORKS, Rochester, NY (US)

(72) Inventor: Hermann J. Stadtfeld, Manderscheid (DE)

(21) Appl. No.: 18/689,136

(22) PCT Filed: Oct. 5, 2022
(86) PCT No.: PCT/US2022/077567

§ 371 Date: Mar. 5, 2024

Related U.S. Application Data
(60) Provisional application No. 63/262,149, filed on Oct. 6, 2021.

(51) Int. Cl. B23F 5/02; B23F 1/02; B23F 1/06; B23F 5/16; B23F 5/20; B23F 17/00

(52) U.S. Cl. CPC B23F 5/02; B23F 1/02; B23F 1/06; B23F 5/163; B23F 5/20; B23F 17/001

(57) ABSTRACT

A machining process for straight bevel gears having very short machining times. In one embodiment. both members of a straight bevel gearset are machined in a non-generated form cutting or a form grinding process. The tool profile has the shape of a mirrored involute which is determined from the equivalent spur gear of each respective straight bevel gear. In another embodiment. one member of a straight bevel gearset is machined in a non-generated form cutting or a form grinding process and the other member of the gearset is machined in a generating process.

### FIELD OF THE INVENTION

The present invention is directed to the manufacture of bevel gears, and in particular to the cutting and/or grinding of straight bevel gears such as differential gears.

### BACKGROUND OF THE INVENTION

Differential gears have a low number of teeth, are coarse pitch (“pitch” is the distance between similar equally spaced tooth surfaces along a given line or curve), and usually have a pressure angle of about 25° or higher. The term “coarse pitch” is used when the number of teeth relative to the diameter of a gear is low. For example, 10teeth on a gear having a diameter of 100 mm (module=100/10=10 mm) is considered to be coarse pitch, whereas 10 teeth on a gear having a diameter of 30 mm (module =30/10=3 mm) is considered to be fine pitch. The skilled artisan generally considers teeth (or gears) with a module lower than 5 mm to be “fine pitch” while teeth (or gears) having a module of 5 mm or more are considered to be “coarse pitch”.

FIG. 1 illustrates an example of a straight bevel differential gear 2 having a plurality of teeth 4 with each tooth having a topland 6, a root portion 8 and tooth flank surfaces 10. The region 12 between opposing tooth surfaces of consecutive teeth is known as a tooth “slot” or “space” with the root portion 8 coinciding with the bottom of the tooth slot.

Traditionally, differential gears have been cut with a large circular cutter, for example, having a cutter diameter of 18, 21 or 25 inches (460, 535 or 635 mm). See, for example, U.S. Pat. No. 2,267,181, the entire disclosure of which is hereby incorporated by reference. The cutting blades are oriented on the periphery of the cutter body, as seen in FIG. 2 for example, and are grouped into roughing blades, semi-finishing blades and finishing blades. The cutter works in a single indexing process and only performs one revolution while cutting a complete tooth slot. The cutter is positioned at the toe end of the tooth slot and moves from toe to heel during a roughing and semi-finishing portion of the cycle in a conventional cutting process. When the cutter reaches the heel end of the tooth slot, all roughing and semi-finishing blades have been used. The cutter then moves back to the toe end in order to finish the tooth slot with the finishing blades in a climb cutting process. Between the last finishing blade and the first roughing blade is a larger space which allows the machine to index the workpiece to the next tooth slot position without the need for the cutter to stop rotating and without the need for a cutter withdraw motion. The tool material is preferably high-speed-steel and the applied surface speed is usually between 20 and 40 m/min, which makes this cutting process a type of broaching process.

The fact that one cutter revolution finishes one slot and includes the indexing time, makes the above-discussed circular broaching process very fast. Compared to straight bevel gear cutting with a pair of inclined rotary cutting tools whose rotating cutting blades effectively interlock to simultaneously cut the same tooth slot (e.g. U.S. Pat. No. 2,567,273) with the same high-speed-steel tool material, the cutting times of the circular broaching process is only a fraction (e.g. 15 to 20%) of the interlocking rotary tools process.

A disadvantage of the circular broaching process is that the workpiece tooth profiles are formed in a profile cutting process which does not enable the creation of a precise octoid tooth form for a conjugate meshing with low motion error. Another disadvantage is the circular broach blade profiles are generally circular instead of involutes or an involute approximation. Yet another disadvantage of the circular broaching is that the process is missing the available freedoms for flank form corrections. Profile cutting with a circular blade profile produces a certain amount of length crowning (i.e. in the direction of the tooth length). The choice of the tooth surface profile curvature radius can produce a profile crowning. The profile (i.e. tooth height, root-to-top direction) crowning has to be large enough to mask the kinematic inaccuracies which exist based on the profile cutting process. Fine tuning of tooth surfaces in order to optimize the rolling performance is nearly impossible without redefining the cutting-edge profiles and manufacturing a new cutter.

After heat treatment, the tooth surfaces of gears cut by the circular broaching process are not hard finished, but are used with the distortions from the heat treatment process. This is sufficient for most practical applications. However, with the increasing demand for high power density and silent operation coming from manufacturers of electric vehicle drive trains, the need for a hard finishing operation is becoming a requirement in many applications.

Another manufacturing method for differential gears, which had its industrial breakthrough in the 1970's, is forging. In forging, a steel billet with temperatures in excess of 2,000° F. (1,093° C.) is pressed in a hard steel die. The die has the negative shape of the toothed side of a differential gear. The bore and back side of the forged parts are machined after the forging process. Some forging processes apply a calibration as a finishing process. The calibration is done after the forging to improve the surface finish as well as the tooth indexing quality. Today, forging achieves high quality differential gears in a very cost-effective manufacturing process. The advantages of forging are low manufacturing cost, the production of parts with a high integrity regarding bending and impacts, and the possibility to apply modifications like the placement of stiffening webs at the toe and heel root as seen in the gear set of FIG. 3, for example, comprising a pinion member and a side gear member (sometimes referred to as the “gear” member of a differential gear set). Some disadvantages are that the stiffening webs constrain the teeth from elastic bending which may lead in high load conditions to surface damages like pitting, and also to cracks in the tooth root. Additionally, with the presence of stiffening webs, the root lines are not straight or curved which makes it impossible to machine with any of the state of the art gear machining processes. Machining would have to be carried out by a slow process using a ball nose endmill and a multi axis machining center for example.

Forged gears have a scale which is a thin outer layer with a higher hardness and a different steel structure. The forging scale also contributes to surface failure under high load. Forged gears have a certain variation of tooth thickness between the first and the last part of a die tool life. This variation results in a changing backlash after assembly which cannot be controlled. Forged differential gears at the beginning of the die tool life are too tight, which reduces the efficiency. Forged gears at the end of the die tool life have too much backlash, which leads to rattling noise and excessive drive train backlash.

Another method for manufacturing straight bevel differential gears is disclosed in U.S. Pat. No. 7,364,391, the entire disclosure of which is hereby incorporated by reference, and in the publication “CONIFLEX®Plus Straight Bevel Gear Manufacture”, Stadtfeld, Hermann J, The Gleason Works, June 2010, and comprises a single side cutting process which roughs out and finish cuts all the first flanks in a first step, and then changes the position of the cutter in order to finish cut all the second flanks in a second step. The two-step process may be carried out on a computer-controlled multi-axis gear manufacturing machine such as that disclosed in U.S. Pat. No. 6,712,566, the entire disclosure of which is hereby incorporated by reference. The two-step process generates precise involutes (octoids) and allows for a variety of flank form modifications. After heat treatment it is possible to grind the differential gears with a CBN grinding process. The two-step process presents a variety of advantages compared to the above-discussed circular broaching or forging, in particular for differentials intended for electric vehicle drive trains. A disadvantage of the two-step process is, with respect to differential gears, lower productivity when compared to circular broaching or forging.

### SUMMARY OF THE INVENTION

The invention comprises a machining process for straight bevel gears having very short machining times. In one embodiment, both members of a straight bevel gearset are machined in a non-generated form cutting or a form grinding process. The tool profile has the shape of a mirrored involute which is determined from the equivalent spur gear of each respective straight bevel gear.

In another embodiment, one member of a straight bevel gearset is machined in a non-generated form cutting or a form grinding process and the other member of the gearset is machined in a generating process.

### BRIEF DESCRIPTION OF THE DRAWINGS

FIG. 1 illustrates an example of differential gear.

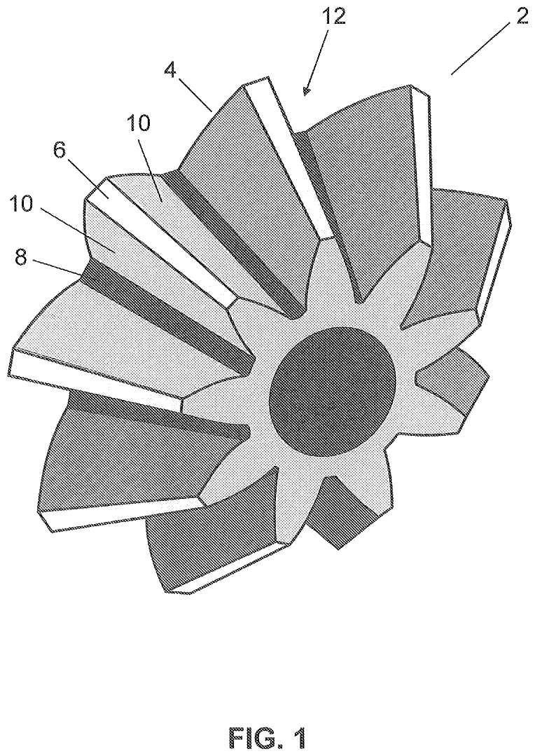

FIG. 2 is a view of a circular broach cutter which is in process of cutting a differential gear tooth slot.

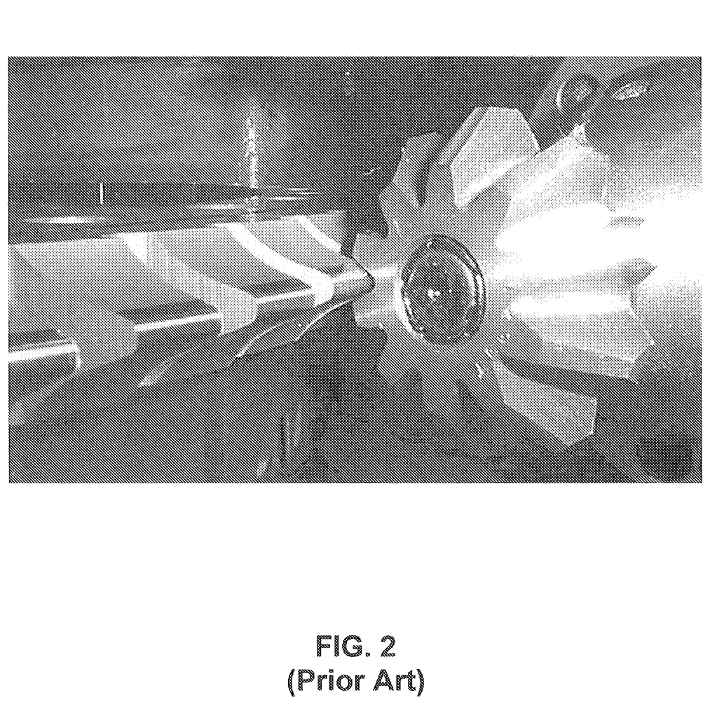

FIG. 3 shows a cross-sectional view of a forged differential gear set.

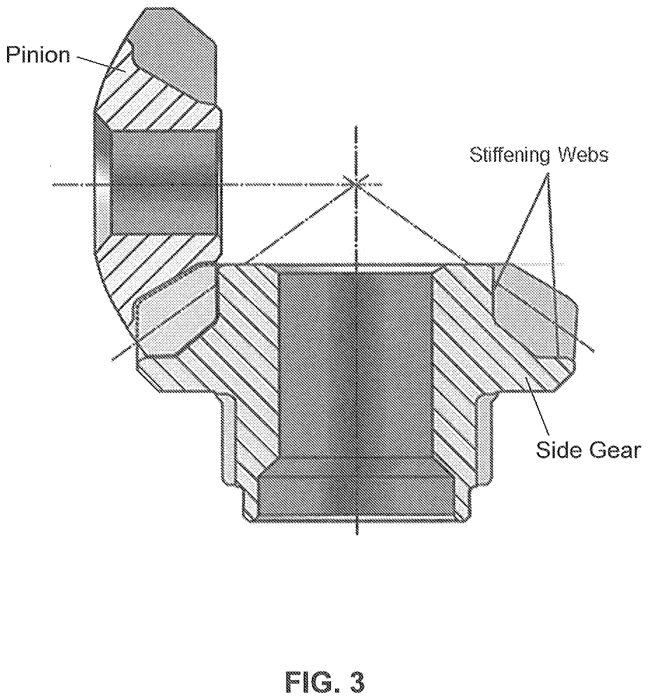

FIG. 4 shows a peripheral cutter for non-generated profile cutting.

FIG. 5 illustrates the orientation of cutter and work piece and the cutting stroke of the inventive process.

FIG. 6 illustrates a differential gear and the radius of equivalent spur gear.

FIG. 7 shows the relationship between pitch point, pressure angle and base circle radius of an equivalent spur gear.

FIG. 8 shows the relationship between base circle and involute point Pi of an equivalent spur gear.

FIG. 9 shows a cross section of cutting or grinding tool of the invention.

FIG. 10 illustrates a front view of the tooth slot width taper of a straight bevel gear.

FIG. 11 illustrates tooth depth taper defined for proportional slot width taper.

FIG. 12 shows the relationship between tool advance or withdraw and machined slot width.

FIG. 13 illustrates machining in one stroke from toe to heel.

FIG. 14 illustrates machining with toe plunge and stroke from toe to heel.

FIG. 15 illustrates machining in one stroke from heel to toe.

FIG. 16 illustrates machining with heel plunge and stroke from heel to toe.

FIG. 17 illustrates non-generated side gear cutting with curved length motion.

FIG. 18 illustrates pinion cutting by a generating process.

### DETAILED DESCRIPTION OF THE PREFERRED EMBODIMENT

The terms “invention,” “the invention,” and “the present invention” used in this specification are intended to refer broadly to all of the subject matter of this specification and any patent claims below. Statements containing these terms should not be understood to limit the subject matter described herein or to limit the meaning or scope of any patent claims below. Furthermore, this specification does not seek to describe or limit the subject matter covered by any claims in any particular part, paragraph, statement or drawing of the application. The subject matter should be understood by reference to the entire specification, all drawings and any claim below. The invention is capable of other constructions and of being practiced or being carried out in various ways. Also, it is understood that the phraseology and terminology used herein is for the purposes of description and should not be regarded as limiting.

The details of the invention will now be discussed with reference to the accompanying drawings which illustrate the invention by way of example only. In the drawings, similar features or components will be referred to by like reference numbers. The size and relative sizes of certain aspects or elements may be exaggerated for clarity or detailed explanation purposes.

The use of “including”, “having” and “comprising” and variations thereof herein is meant to encompass the items listed thereafter and equivalents thereof as well as additional items. The use of letters or numbers to identify elements of a method or process is simply for identification and is not meant to indicate that the elements should be performed in a particular order. As used herein, the singular forms “a”, “an” and “the” are intended to include the plural forms as well, unless the context clearly indicates otherwise and the term “and/or” includes any and all combinations of one or more of the associated listed items.

Although references may be made below to directions such as upper, lower, upward, downward, rearward, bottom, top, front, rear, etc., in describing the drawings, these references are made relative to the drawings (as normally viewed) for convenience. These directions are not intended to be taken literally or limit the present invention in any form. In addition, terms such as “first”, “second”, “third”, etc., are used to herein for purposes of description and are not intended to indicate or imply importance or significance unless explicitly stated.

The invention comprises a method of manufacturing at least one member of a mating pair of straight bevel gears comprising a first member and a second member. The first workpiece blank is machined to produce the first member. The machining is a non-generating process comprising feeding a rotating tool in a stroking motion from one of a toe end or heel end of the first workpiece blank to the other of a toe end or heel end of the first workpiece blank to form a tooth slot and opposing tooth flanks on the first workpiece blank. The first workpiece blank is indexed to another tooth slot position and the steps of feeding and indexing are repeated until all tooth slots and all tooth flanks are produced thereby forming the first member.

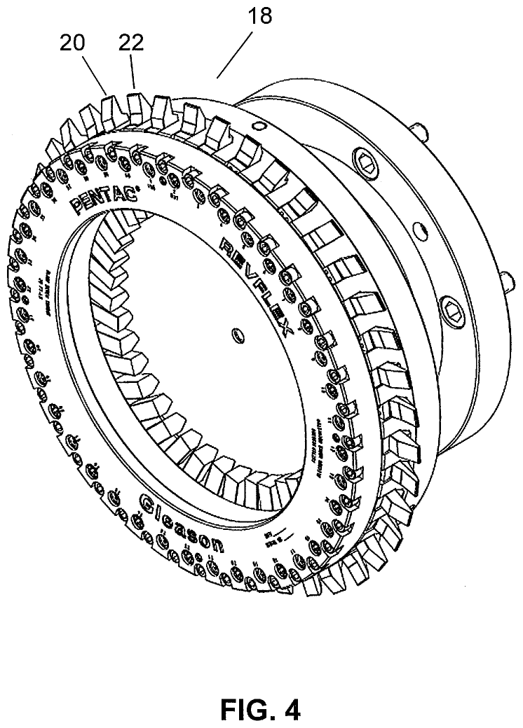

The inventive machining method produces straight bevel gears with the typical attributes of differential gears which are: coarse pitch teeth, large tooth depth taper and high pressure angles. The inventive method is preferably carried out with a peripheral cutter 18 having a large diameter and a plurality of alternating inside cutting blades 20 and outside cutting blades 22. Alternatively, full-profile cutting blades that each cut both sides and the bottom of a tooth slot simultaneously (i.e. the entire tooth slot) may also be utilized. FIG. 4 shows a three-dimensional view of a peripheral cutter for non-generated, completing tooth profile cutting. The preferred cutter for the inventive process has a large diameter (e.g. 460 mm) and carries a high number (e.g. 40) of cutting blades (e.g. stick or bar blades) around its circumference. The side surfaces of the blade sticks are oriented to match with the plane of rotation. The front surfaces of the blade sticks have an inclination versus a radial line of, for example, 7.42 degrees.

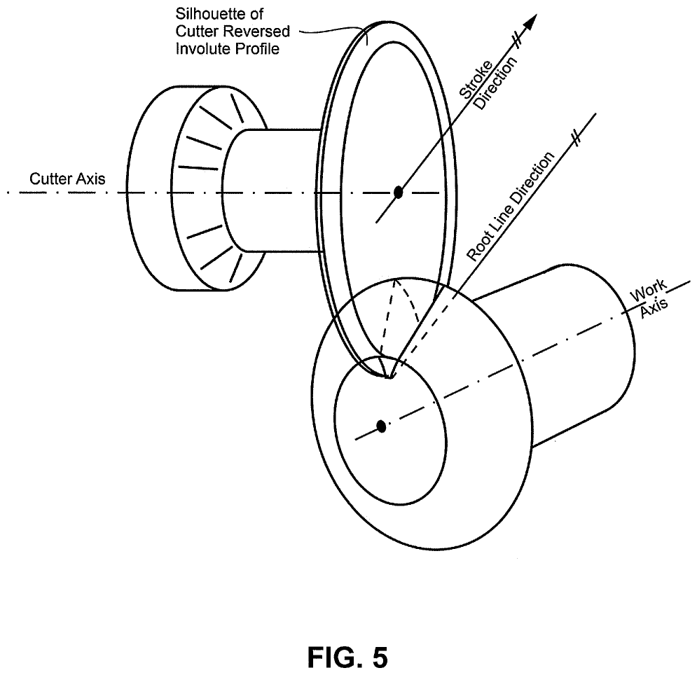

In order to form a straight root line without a generating motion, a first embodiment of the inventive method is a non-generating form cutting process which preferably cuts one tooth slot from the toe end to the heel end in one stroke as shown in FIG. 5. The stroke direction is parallel to the root line of the machined straight bevel gear. Both flanks of each slot are finished at the same time. With carbide as the preferred cutting blade material, cutting edges that are 3-face ground (i.e. front face and both side surfaces) and all-around coated with a wear coating (e.g. TiAIN or AICrN), the inventive completing process enables productivity similar to the previously-discussed circular broaching process. The stroke direction could be reversed, i.e. toe end to heel end. Alternate direction strokes could be used to produce consecutive tooth slots.

The inventive process preferably uses involute blade profiles (or blade profiles which approximate involutes with three connected circles). The profiles of the cutter blades are curved like mirrored involutes in order to create an involute profile on the cut gears. The blade profiles may be modified in order to achieve profile crowning, tip relief and/or root relief on the tooth. By applying tip and root relief, the profile center can stay conjugate which results in a low motion transmission error, low noise and higher load carrying capacity. Preferably, the cutting tool is guided through the tooth slot utilizing a five (or more) axis computer-controlled (e.g. CNC) machine, such as the previously disclosed U.S. Pat. No. 6,712,566 for example, which enables the formation of certain flank form modifications, such as length crowning and flank twisting. It is also possible to apply psychoacoustic tooth flank form scattering with the goal to reduce audible noise.

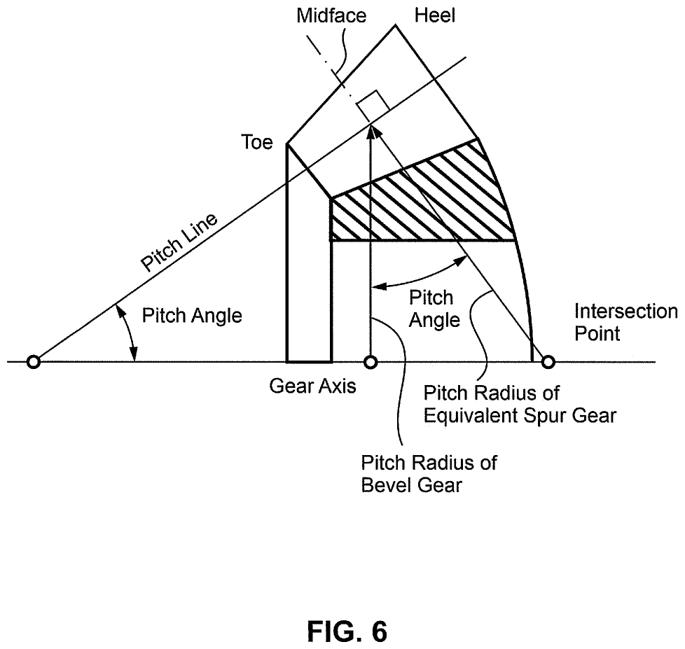

The involute parameters are determined from an equivalent spur gear, defined at midface as shown in FIG. 6, which shows a two-dimensional view of a straight bevel gear cross section. The equivalent spur gear is used in the standards (e.g. AGMA, etc.) in order to relate certain features of straight bevel gears to an equivalent spur gear. In order to achieve a comparable (equivalent) kinematic between the original straight bevel gear and the equivalent spur gear, the momentum pole of the rotation at midface of the straight bevel gear is used to define the pitch diameter of the equivalent spur gear (pitch diameter of straight bevel gear/cos (pitch angle)=pitch diameter of equivalent spur gear). The tooth proportions of the equivalent spur gear are identical to the straight bevel gear which means that in both cases, the same module and pressure angle applies. With the known pitch diameter and pressure angle of the equivalent spur gear, the involute of the spur gear can be calculated. The involute of the equivalent spur gear can now be used for the straight bevel gear. In most cases, it is practical and sufficiently accurate to apply the involute of the equivalent spur gear (defined from the midface dimensions of the straight bevel gear) to the entire face width of the straight bevel gear.

In the following discussion and equations, the units of length/distance measurement is preferably in millimeters (mm) but alternatively, may be in inches. At midface (see FIG. 6), which is in the center between toe and heel, a line is shown that is perpendicular to the pitch line. This line intersects the gear axis at the intersection point. The length of this line from the intersection point to the pitch line is the pitch radius of the equivalent spur gear. It is calculated by dividing the pitch radius of the bevel gear by the cosine of the pitch angle. The pitch diameter at midface of the differential gear is divided by the cosine of the pitch angle to receive the equivalent spur gear pitch diameter:

Equivalent Spur Gear Pitch Diameter=Pitch Diameter/cos(Pitch Angle) (1)

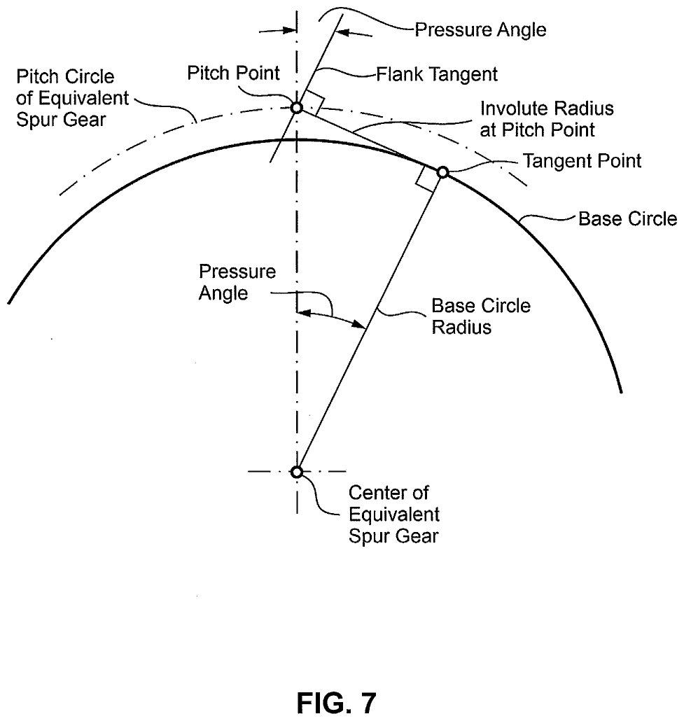

FIG. 7 shows a two-dimensional relationship between pitch point, pressure angle and base circle radius. The pitch circle of the equivalent spur gear (dashed arcuate line) is shown located around the center of the equivalent spur gear. A vertical dashed line extends from the center of the equivalent spur gear to the pitch circle and beyond. The intersection of the vertical line with the pitch circle defines the pitch point. A straight line (i.e. flank tangent line) is inclined with respect to the vertical line direction by an amount equal to the pressure angle and extends through the pitch point. Perpendicular to the flank tangent and beginning at the pitch point, an involute radius line extends to the right and is tangent to the involute base circle at the tangent point. A line perpendicular to the involute base circle tangent extends from the tangent point and intersects the center of the equivalent spur gear. The length of this line is the radius of the base circle of the equivalent spur gear. The distance between tangent point (at the involute base circle) and the pitch point defines the length of the involute radius at the pitch point.

The base circle of the involute is calculated from the graphic in FIG. 7:

Base Circle Diameter=Equivalent Spur Gear Pitch Diameter×cos (Pressure Angle) (2)

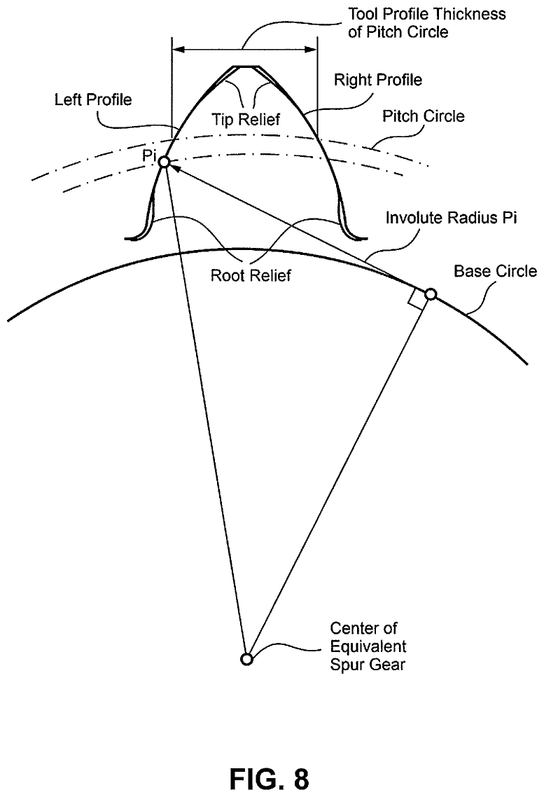

FIG. 8 shows a two-dimensional view of the relationship between base circle and involute point Pᵢ of the equivalent spur gear. FIG. 8 also shows the tooth profile as it is developed point by point using the involute radius. The profile generated this way is the profile of the real straight bevel gear at midface. The profile is also used to determine the cutting blade profile as a mirror image. FIG. 8 further shows the tooth profile thickness at the pitch circle. It is optional to introduce a tip and root relief as shown in the graphic of FIG. 8.

The involute radius is calculated for each profile point separately (in FIG. 8 shown for point Pᵢ):

Involute Radius Pᵢ=\sqrt{(Radius Point Pᵢ)²−[ Base Circle/2]²} (3)

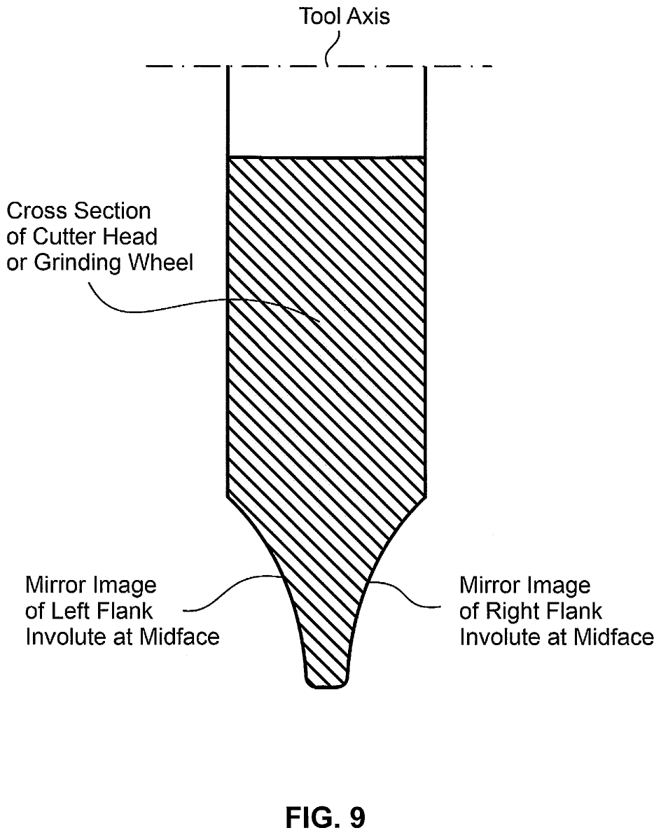

The tool profile is the negative profile of the gear slot at midface which may also be referred to as the mirror image or reversed involute. FIG. 9 shows a cross section of the tool profile.

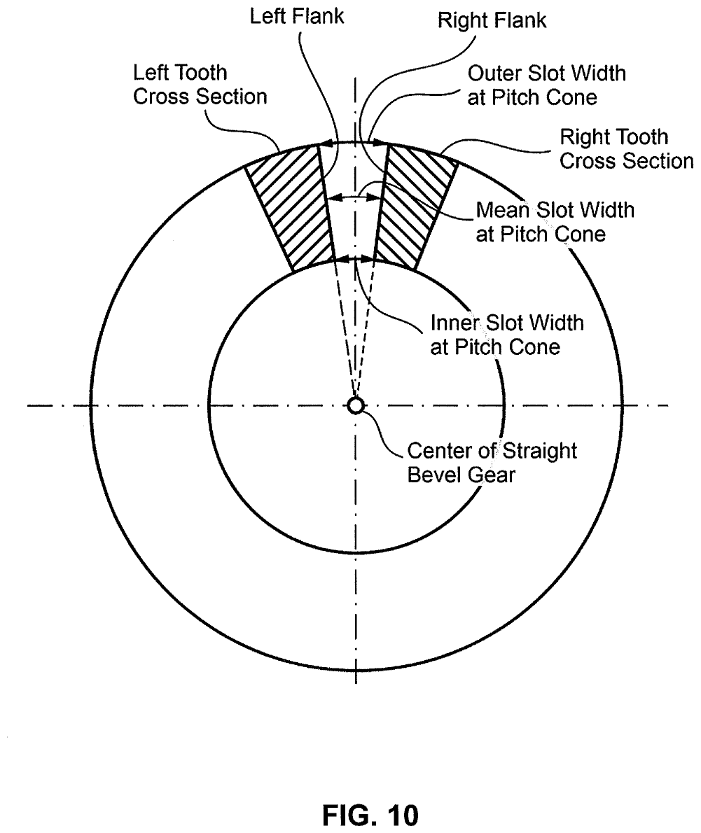

Cutting from toe to heel (or vice versa) and finishing both flanks of one slot simultaneously requires machining a proportional slot width taper along the pitch lines of the left and right flank of a tooth slot (see FIG. 10). Proportional means that the extended flank lines in the pitch cone direction intersect with the axis of the straight bevel gear (shown in the front view in FIG. 10 as “Center of Straight Bevel Gear”). FIG. 10 shows a proportional slot width taper wherein the slot width begins with zero width at the center of the straight bevel gear and increases proportionally. At each radial location, the circumference at that location is divided by twice the number of teeth. This delivers equal tooth thicknesses and slot width of both mating gears. In order to balance the strength between the two mating members, it is possible later to add a certain amount stock material to one of the two members and subtract the same amount of stock material from the other member (profile side shift). After introducing a profile side shift, the slot width taper is still proportional.

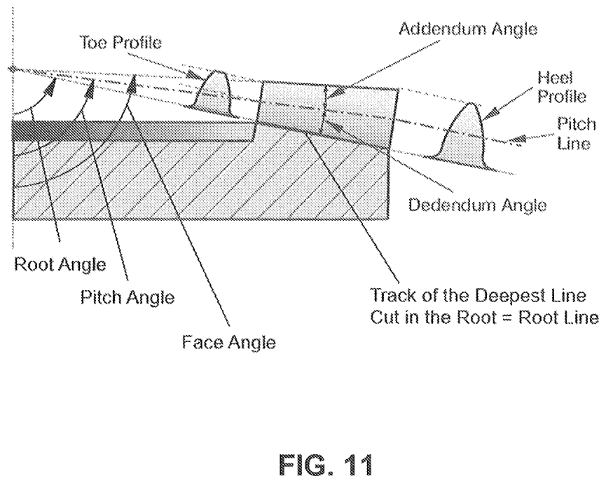

A proportional slot width taper can be achieved by defining a particular dedendum angle (angle between pitch line and root line as shown in FIG. 11). FIG. 11 shows a two-dimensional view of the cross section of a bevel gear. The tooth depth taper for a straight bevel gear, machined in a completing process requires a dedendum angle. The dedendum angle is determined in order to provide a proportional tooth slot width along the pitch lines. The dedendum angle is subtracted from the pitch angle to obtain the root angle. For uniform top root clearance between the two mating members, the face angle may be determined by adding the dedendum angle to the pitch angle.

One manner to determine the dedendum angle is shown below.

Tooth slot width calculation at the pitch line at midface, toe and heel (in arc length):

Mean Slot Width at Pitch Line=(Pitch Diameter at Midface)×(π/2/Number of Teeth) (4)

Toe Slot Width at Pitch Line=(Pitch Diameter at Toe)×(π/2/Number of Teeth) (5)

Heel Slot Width at Pitch Line=(Pitch Diameter at Heel)×(π/2/Number of Teeth) (6)

The amount that the tooth slot must be shallower at the toe:

ΔToe=(Toe Slot Width at Pitch Line−Mean Slot Width at Pitch Line)/2/tan (Pressure Angle) (7)

The amount that the slot must be deeper at the heel:

ΔHeel=(Heel Slot Width at Pitch Line−Mean Slot Width at Pitch Line)/2/tan (Pressure Angle) (8)

The dedendum angle is then determined by:

Dedendum Angle=arctan((ΔHeel−ΔToe)/Face Width) (9)

This allows the root angle of a particular gear to be determined by:

Root Angle=Pitch Angle−Dedendum Angle (10)

Backlash between the two mating members is created by increasing the tool profile thickness at the pitch circle (which reduces the tooth profile thickness, shown in FIG. 8) of each respective member by half of the desired backlash amount.

In order to achieve a parallel top-root clearance between the meshing members, the face angle can be determined by:

Face Angle=Pitch Angle+Dedendum Angle (11)

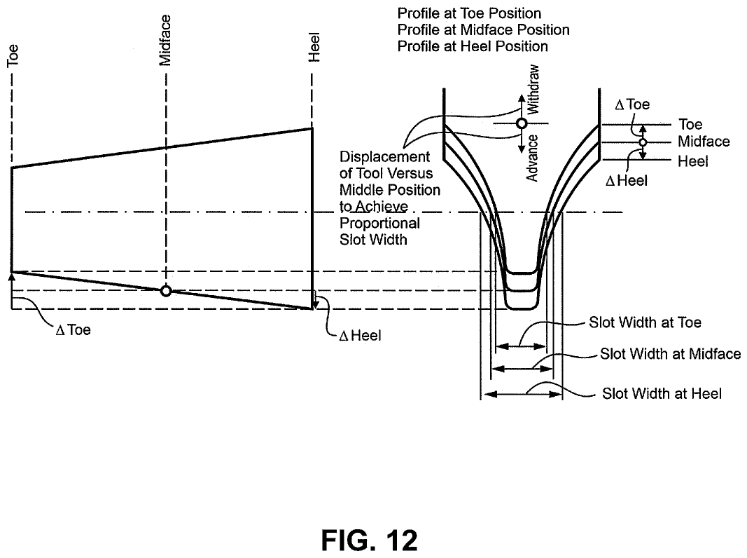

The relationship between the position of the tool at midface, toe and heel is shown in FIG. 12. From midface towards the heel the tool is advanced (relative to the pitch line) such that it cuts a deeper slot. From midface towards the toe the tool is withdrawn (relative to the pitch line) such that it cuts a shallower slot. The tips of the cutting blades follow the root line of the work piece resulting in the proper depth and width of the tooth slot along its length between the toe end and the heel end.

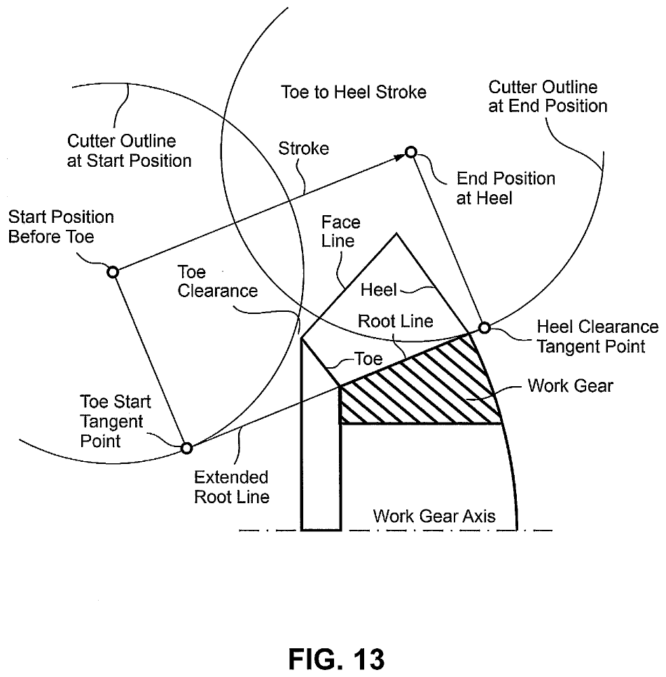

For the motions during the slot cutting, four examples are explained. Example 1 is shown in FIG. 13 which shows a two-dimensional view of the cross section of a straight bevel differential gear and a simplified view of a cutter head in the start position (before the toe) and the end position (at the heel) of the machining process. The cutter performs one stroke motion from toe to heel in order to complete both flanks of one slot. In the start position, the cutter is located before the toe with the cutter outline circle being tangential to the extended root line. In the start position, the cutter clears the part with a small amount of toe clearance. From the start position, the stroke moves the cutter to the end position at the heel, such that the tangent point is outside of the slot by a small (heel clearance tangent point).

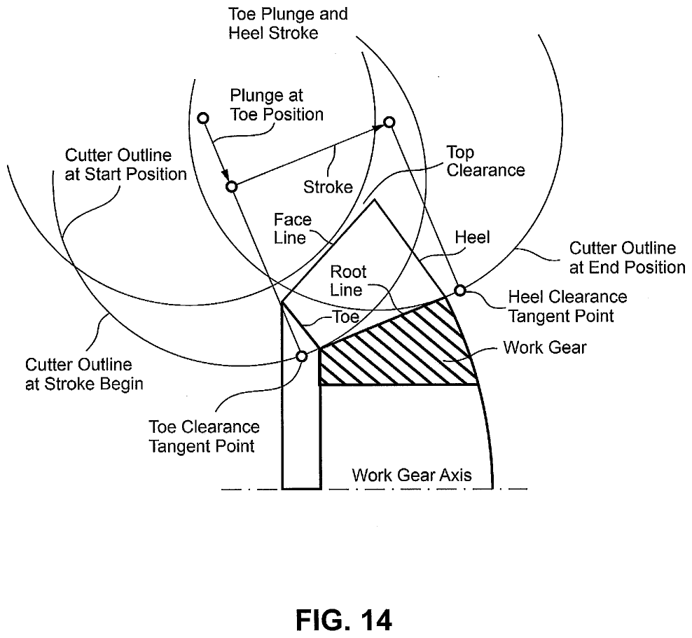

Example 2 is shown in FIG. 14 which shows a two-dimensional view of the cross section of a straight bevel differential gear and a simplified view of a cutter head in the start position (at the toe, withdrawn from the root line). The cutter plunges from the start position to the root line and then moves with a stroke motion to the end position at the heel in order to complete both flanks of one slot. In the start position, the cutter is located at the toe, but withdrawn from the root line, such that it clears the blank (top clearance). From the start position, the cutter plunges until the cutter outline reaches the toe clearance tangent point. The plunge is followed by a stroke from toe to heel. The stroke ends at the heel clearance tangent point.

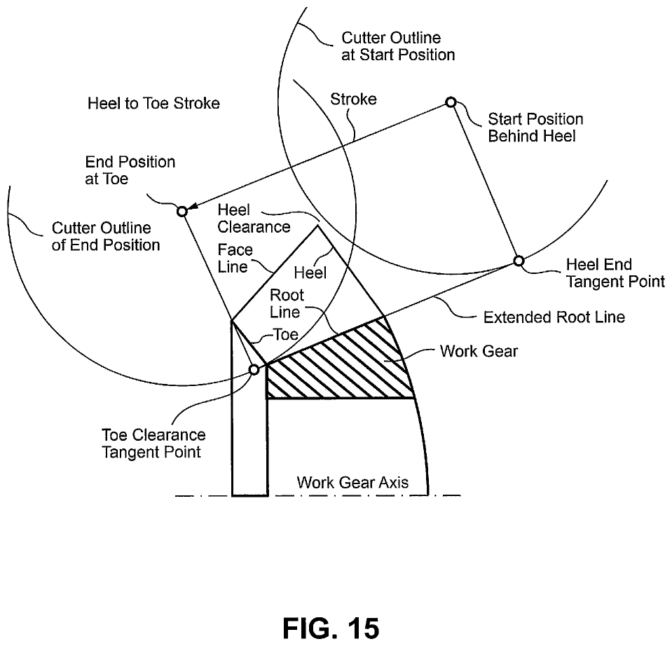

Example 3 is shown in FIG. 15 which shows a two-dimensional view of the cross section of a straight bevel differential gear and a simplified view of a cutter head in the start position (behind the heel) and the end position (at the toe) of the machining process. The cutter performs one stroke motion from heel to toe in order to complete both flanks of one slot. In the start position, the cutter is located behind the heel with the cutter outline circle being tangential to the extended root line. In the start position, the cutter clears the part with a small amount of heel clearance. From the start position, the stroke moves the cutter to the end position at the toe, such that the tangent point is outside of the slot by a small (toe clearance tangent point).

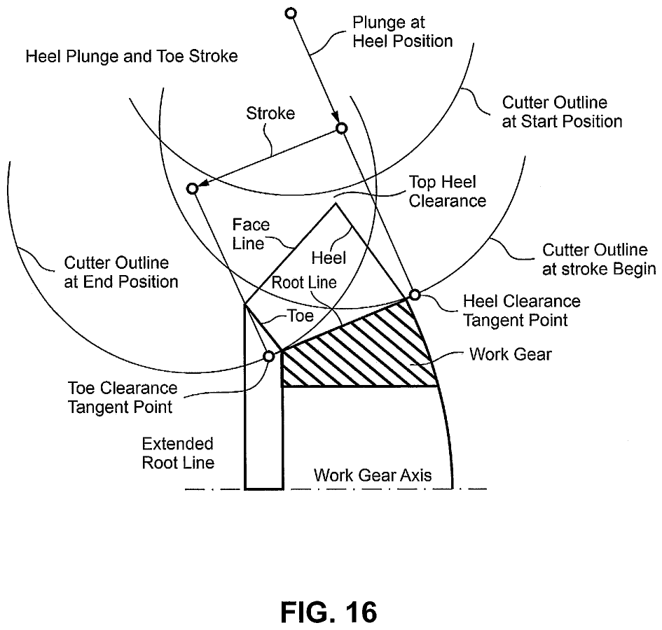

Example 4 is shown in FIG. 16 which shows a two-dimensional view of the cross section of a straight bevel differential gear and a simplified view of a cutter head in the start position (at the heel, withdrawn from the root line). The cutter plunges from the start position to the root line and then moves with a stroke motion to the end position at the toe in order to complete both flanks of one slot. In the start position, the cutter location is at the heel, but withdrawn from the root line, such that it clears the blank (top-heel clearance). From the start position, the cutter plunges until the cutter outline reaches the heel clearance tangent point. The plunge is followed by a stroke from heel to toe. The stroke ends at the toe clearance tangent point.

The process is not limited to cutting but is also applicable to other machining processes such as hard skiving and grinding.

Furthermore, the process is not limited to one stroke. It is also possible to use the described stroke for roughing and a reverse stroke for finishing.

Also, the invention is not limited to completing processes but includes roughing and finishing a first tooth flank surface with a first stroke and then finishing the second (i.e. opposite) tooth flank surface with the reverse stroke (with different settings).

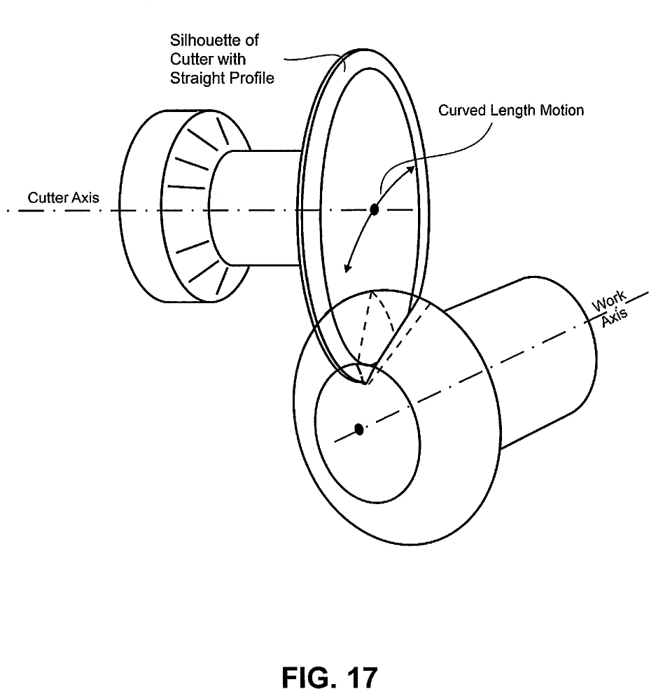

In a second embodiment, the side gear member of the gear set is non-generated in a manner similar to the first embodiment discussed above but the pinion member is generated (or vice-versa). For the non-generated side gear member, the tooth slot is produced by a form cutting process which preferably cuts one tooth slot from toe end to heel end (or heel end to toe end) in one stroke as shown in FIG. 17. In order to eliminate toe and heel edge contact that may occur when rolling in mesh with a generated pinion, the stroke length motion is not straight (like the stroke direction in FIG. 5) but is curved to cut gradually deeper towards the tooth ends. The cutter has straight sided alternating cutting edges (i.e. inside and outside cutting blades) and produces both tooth flanks from a start position (e.g. toe end) to an end position (e.g. heel end).

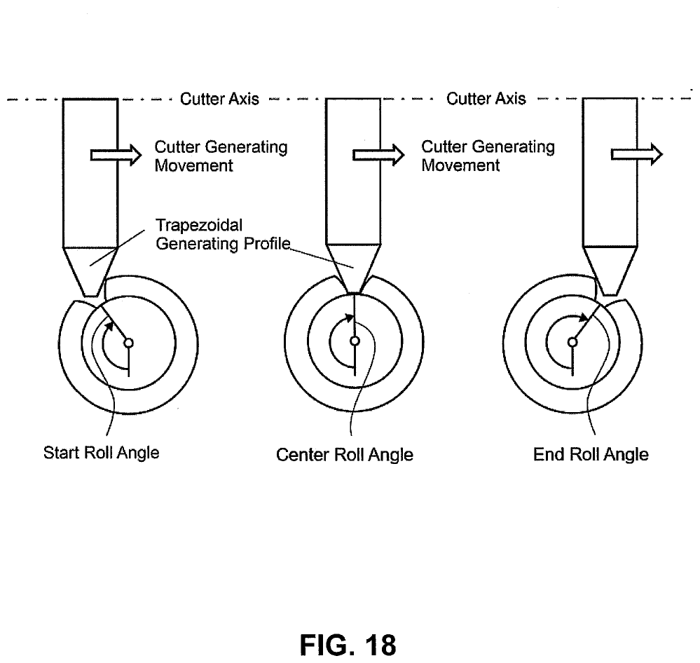

FIG. 18 shows generation of a pinion member in a plane (represented by the drawing page) which represents an unrolled cylinder. The cylinder has an axis that is parallel to the plane and perpendicular to the cutter axis in FIG. 18. The radius of the cylinder is equal to the mean cone distance of the mating side gear. The cutter has a trapezoidal cutting-edge profile and performs a linear movement (in the drawing plane, representing the unrolled cylinder) from a start roll angle position to an end roll angle position of the pinion. Simultaneously with the linear cutter movement, the pinion rotates in order to generate the tooth profile. The cutting blades do not have a reversed involute profile as in case of the first embodiment (FIG. 9) but have a straight cutting-edge which may be modified to include a blade profile edge curvature radius to create some profile crowning on the tooth surface. The pinion generation uses the mating non-generated side gear as the theoretical generating gear. This provides additional curvature in the profile of the pinion tooth surfaces such that the side gear tooth profile can be straight for a correct gear meshing action.

Because the pinion cutter performs no length movement, the root line will be curved with the radius of the cutter. This arrangement will cause a stock-on condition at the two ends of the teeth. The stock-on condition causes a negative length crowning and may result in edge contact at the toe and heel end when rolling in mesh with an unmodified tooth surface of a side gear. However, as discussed above, in order to eliminate toe and heel edge contact during rolling, the stroke length motion is not straight during the non-generated production of the side gear (like the stroke direction in FIG. 5) but curved to cut gradually deeper towards the tooth ends (FIG. 17).

The invention also contemplates the pinion member being non-generated and the side gear member being generated, as well as both pinion member and side gear member being manufactured by a respective generating process.

In addition to the generating motions described above and illustrated in FIG. 18, the tooth flank surfaces of the generated pinion may be further optimized such as with the introduction of flank twist control, lengthwise crowning and/or other tooth flank surface modifications such as those disclosed in U.S. Pat. No. 5,580,298 the entire disclosure of which is hereby incorporated by reference.

While the invention has been described with reference to preferred embodiments it is to be understood that the invention is not limited to the particulars thereof. The present invention is intended to include modifications which would be apparent to those skilled in the art to which the subject matter pertains without deviating from the spirit and scope of the appended claims.

What is claimed is:

1. A method of manufacturing at least one member of a mating pair of straight bevel gears comprising a first member and a second member, said method comprising:
machining a first workpiece blank to produce said first member, said machining being a non-generating process comprising feeding a rotating tool in a stroking motion from one of a toe end or heel end of the first workpiece blank to the other of a toe end or heel end of the first workpiece blank to form a tooth slot and opposing tooth flanks on said first workpiece blank,
indexing the first workpiece blank to another tooth slot position, repeating said feeding and indexing until all tooth slots and all tooth flanks are produced thereby forming said first member.

2. The method of claim 1 wherein said tool is a peripheral cutting or grinding tool.

3. The method of claim 2 wherein said peripheral cutting tool comprises a plurality of alternating inside cutting blades and outside cutting blades.

4. The method of claim 3 wherein the inside cutting blades and outside cutting blades having curved blade profiles in the form of mirrored involutes in order to create an involute profile on the tooth flanks.

5. The method of claim 1 wherein said stroking motion comprises a single stroke.

6. The method of claim 1 wherein said stroking motion is straight or curved.

7. The method of claim 6 wherein said curved stroking motion machines the tooth slot deeper towards the toe end and heel end of the tooth slot.

8. The method of claim 1 wherein the tool is plunge-fed relative to the first workpiece blank to a predetermined tooth slot depth at the toe end or the heel end prior to commencing said stroking motion.

9. The method of claim 1 further comprising:
performing a finishing operation on said tooth flanks to provide a finished tooth surface on said tooth flanks.

10. The method of claim 9 wherein said finishing operation comprises grinding or hard skiving.

11. The method of claim 1 further comprising machining a second workpiece blank to produce said second member, said machining being a generating process comprising:
engaging a rotating tool with a second workpiece blank and generating a tooth slot and opposing tooth flanks on said second workpiece blank by moving the rotating tool in a linear direction combined with rotating the second workpiece blank from a start roll angle to an end roll angle,
indexing the second workpiece blank to another tooth slot position, repeating said engaging, generating and indexing until all tooth slots and all tooth flanks are produced thereby forming said second member.

12. The method of claim 11 wherein said tool is a peripheral cutting or grinding tool.

13. The method of claim 12 wherein said peripheral cutting tool comprises a plurality of alternating inside cutting blades and outside cutting blades.

14. The method of claim 13 wherein the inside cutting blades and outside cutting blades form a trapezoidal cutting-edge profile.

15. The method of claim 11 further comprising:
performing a finishing operation on said tooth flanks to provide a finished tooth surface on said tooth flanks.

16. The method of claim 15 wherein said finishing operation comprises grinding or hard skiving.

17. A method of manufacturing at least one member of a mating pair of straight bevel gears comprising a first member and a second member, said method comprising:
machining a first workpiece blank to produce said first member, said machining being a non-generating process comprising feeding a rotating tool in a stroking motion from one of a toe end or heel end of the first workpiece blank to the other of a toe end or heel end of the first workpiece blank to form a tooth slot and opposing tooth flanks on said first workpiece blank,
indexing the first workpiece blank to another tooth slot position, repeating said feeding and indexing until all tooth slots and all tooth flanks are produced thereby forming said first member,
or,
engaging a rotating tool with a first workpiece blank and generating a tooth slot and opposing tooth flanks on said first workpiece blank by moving the rotating tool in a linear direction combined with rotating the first workpiece blank from a start roll angle to an end roll angle,
indexing the first workpiece blank to another tooth slot position, repeating said engaging, generating and indexing until all tooth slots and all tooth flanks are produced thereby forming said first member.

18. The method of claim 17 wherein said tool is a peripheral cutting or grinding tool.

19. The method of claim 17 further comprising:
performing a finishing operation on said tooth flanks to provide a finished tooth surface on said tooth flanks.

20. The method of claim 19 wherein said finishing operation comprises grinding or hard skiving.
